(19) United States
(12) Patent Application Publication
(10) Pub. No.: US 2008/0043077 A1
(43) Pub. Date: Feb. 21, 2008

(54) INKJET PRINTHEAD HAVING BEZEL STRUCTURE TO REMOVE INK BUBBLES

(75) Inventors: Young-ki Hong, Anyang-si (KR); Jae-woo Chung, Yongin-si (KR); Jong-beom Kim, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/756,021

(22) Filed: May 31, 2007

(30) Foreign Application Priority Data
Jul. 6, 2006 (KR) 2006-63503

(51) Int. Cl. B41J 2/19

(52) U.S. Cl. 347/92

(57) ABSTRACT

An inkjet printhead having a bezel structure to remove ink bubbles. The inkjet printhead includes a channel plate having an ink channel, actuators formed on the channel plate to provide driving forces to eject the ink, and an ink-supply bezel coupled to the channel plate. The ink-supply bezel includes an ink reservoir that is connected to an ink inlet and stores ink that is to be supplied to the ink channel, an ink supply port through which ink is supplied to the ink reservoir, and an air discharge port through which bubbles that are removed from the ink of the ink reservoir are discharged. The ink supply port and the air discharge port can be formed closed to both ends of the top surface of the ink reservoir, respectively. The ink supply port can have a bottom end lower than that of the air discharge port. The ink reservoir can include a sloped ceiling surface. Therefore, ink bubbles can be effectively removed from the ink before the ink is supplied to the ink channel.

### CROSS-REFERENCE TO RELATED APPLICATIONS

This application claims the benefit of Korean Patent Application No. 10-2006-0063503, filed on Jul. 6, 2006, in the Korean Intellectual Property Office, the disclosure of which is incorporated herein in its entirety by reference.

### BACKGROUND OF THE INVENTION

1. Field of the Invention

The present general inventive concept relates to an inkjet printhead, and more particularly, to an inkjet printhead having an ink-supply bezel to remove bubbles from ink.

2. Description of the Related Art

Inkjet printheads are devices used to form color images on printing mediums by firing droplets of ink onto a desired region of a corresponding printing medium. Inkjet printheads can be classified into two types, which are thermal inkjet printheads and piezoelectric inkjet printheads, depending on the used ink ejecting method. The thermal inkjet printhead generates bubbles by using heat and ejects the ink by utilizing the expansion of the bubbles, and the piezoelectric inkjet printhead ejects ink using a pressure generated by deforming a piezoelectric material.

FIG. 1 is a cross-sectional view schematically illustrating a general structure of a conventional piezoelectric inkjet printhead. Referring to FIG. 1, a manifold 2, a restrictor 3, a pressure chamber 4, and a nozzle 5 are formed in a channel plate 1 to form an ink channel, and a piezoelectric actuator 6 is disposed on the channel plate 1. The manifold 2 is a common passage through which ink is supplied from an ink tank (not shown) to pressure chambers such as the pressure chamber 4. The restrictor 3 is a passage formed between the pressure chamber 4 and the manifold 2. The pressure chamber 4 is formed to receive ink that is to be ejected. The piezoelectric actuator 6 operates to change the volume of the pressure chamber 4, and thereby, resulting in variations of the pressure in the pressure chamber 4. Thus, ink can be ejected from or introduced into the pressure chamber 4.

Ink channels can be respectively formed of ceramic, metal, or synthetic resin plates so as to be thin, and then, the plates can be stacked to form the channel plate 1. The piezoelectric actuator 6 is formed on the channel plate 1 above the pressure chamber 4. The piezoelectric actuator 6 has a stacked structure formed by a piezoelectric layer and electrodes. The electrodes are used to apply a voltage to the piezoelectric layer. Therefore, a portion of an upper wall of the channel plate 1 forming a top wall of the pressure chamber 4 is used as a vibration plate 1a that is deformed by the piezoelectric actuator 6.

An operation of the conventional piezoelectric inkjet printhead will now be described. When the piezoelectric actuator 6 deforms the vibration plate 1a to reduce the volume of the pressure chamber 4, the pressure in the pressure chamber 4 increases, and thus, ink is ejected to the outside of the pressure chamber 4 through the nozzle 5. When the piezoelectric actuator 6 allows the vibration plate 1a to return its original shape in order to increase the volume of the pressure chamber 4, the pressure in the pressure chamber 4 decreases, and thus, ink is introduced into the pressure chamber 4 from the manifold 2 through the restrictor 3.

FIG. 2 is a perspective view illustrating a piezoelectric inkjet printhead disclosed in Korean Patent Laid-Open Publication NO. 2003-0050477 (U.S. Patent Publication NO. 2003-0112300) filed by the applicant of the present invention.

Referring to FIG. 2, the piezoelectric inkjet printhead includes three silicon substrates: an upper substrate 30, a middle substrate 40, and a lower substrate 50 that are bonded to one another. The upper substrate 30 includes a plurality of pressure chambers 32 formed in its bottom surface to a predetermined depth. An ink inlet 31 is formed through the upper substrate 30 and connected to an ink tank (not illustrated). The pressure chambers 32 are arranged in two rows at both sides of a manifold 41 formed in the middle substrate 40. Piezoelectric actuators 60 are disposed on a top surface of the upper substrate 30 to apply driving forces to their respective pressure chambers 32 in order to eject ink from the pressure chambers 32. The manifold 41 formed in the middle substrate 40 is connected to the ink inlet 31 of the upper substrate 30. Restrictors 42 are formed at both sides of the manifold 41, and are respectively connected to the pressure chambers 32 of the upper substrate 30. A plurality of vertical dampers 43 are formed through the middle substrate 40 relatively corresponding to the pressure chambers 32. A plurality of nozzles 51 are formed in the lower substrate 50, and connected to the dampers 43, respectively. Each of the nozzles 51 includes an ink introduction portion 51a and an ink ejection portion 51b. The ink introduction portion 51a is formed in an upper portion of the lower substrate 50, and the ink ejection portion 51b is formed in a lower portion of the lower substrate 50. The ink introduction portion 51a is formed in a reversed pyramid shape by anisotropic wet etching, the ink ejection portion 51b is formed in a cylindrical shape having a constant diameter by dry etching.

Bubbles may be contained in ink supplied to an ink channel. However, conventional inkjet printheads, such as those illustrated in FIGS. 1 and 2, are not formed with a structure to remove the bubbles in the ink. In this case, the bubbles in the ink can reach a nozzle 51 along an ink channel to cause an unstable meniscus at the nozzle 51 or hinder ejection of ink droplets from the nozzle 51. Hence, the bubbles in the ink affect ink ejection characteristics of the conventional inkjet printheads in terms of, for example, ink droplet speed and volume, and thereby, causing deterioration in image quality.

### SUMMARY OF THE INVENTION

The present general inventive concept provides an inkjet printhead including an ink-supply bezel to remove bubbles from the ink in order to improve the ink ejection performance of the inkjet printhead.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing an inject printhead including: a channel plate including an ink channel, the ink channel including an ink inlet receiving ink, a plurality of chambers filled with the ink received through the ink inlet, and a plurality of nozzles through which the ink is ejected from the chambers; actuators formed on the channel plate to apply driving forces to eject ink from the chambers; and an ink-supply bezel coupled to a top surface of the channel plate, wherein the ink-supply bezel includes: an ink reservoir that is connected to the ink inlet and stores ink that is to be supplied to the ink channel of the channel plate; an ink supply port through which ink is supplied to the ink reservoir; and an air discharge port through which bubbles removed from the ink stored in the ink reservoir are discharged.

The ink supply port and the air discharge port may be formed closed to both ends of the top surface of the ink reservoir, respectively.

The ink supply port may have a bottom end lower than a bottom end of the air discharge port. The bottom end of the ink supply port may be immersed in the ink stored in the ink reservoir. The bottom end of the air discharge port may be flush with a ceiling surface of the ink reservoir.

The ink reservoir may comprise a sloped ceiling surface. The ceiling surface of the ink reservoir may be sloped upward from the bottom end of the ink supply port to the bottom end of the air discharge port.

The ink-supply bezel may include an opening through which the actuators are exposed.

The ink channel may further include: a manifold to supply the ink received through the ink inlet to the chambers; and a plurality of restrictors to respectively connect the manifold to the chambers.

The manifold may include a plurality of sub manifolds that are separate from each other by a plurality of first barrier walls respectively corresponding to the chambers. The ink inlet may include a plurality of sub ink inlets that are separate from each other by a plurality of second barrier walls. Each of the sub ink inlets may correspond to two to four of the sub manifolds.

The channel plate may include an upper substrate, a middle substrate, and a lower substrate.

The ink channel may further include: a manifold to supply the ink received through the ink inlet to the chambers; and a plurality of restrictors to respectively connect the manifold to the chambers, wherein the chambers are formed in a bottom surface of the upper substrate to a predetermined depth, the ink inlet is formed vertically through the upper substrate, the manifold and the restrictors are formed in the middle substrate, and the nozzles are formed vertically through the lower substrate.

The ink channel may further include a plurality of dampers formed vertically through the middle substrate to respectively connect the chambers to the nozzles.

Each of the actuators may include: a lower electrode formed on the upper substrate; a piezoelectric layer formed on the lower electrode above the chamber; and an upper electrode formed on the piezoelectric layer to apply a voltage to the piezoelectric layer.

The foregoing and/or other aspects and utilities of the present general inventive concept are achieved by providing an ink supply bezel usable with an inkjet printhead, the ink supply bezel including an opening extending along a length thereof to receive piezo-electric actuators; an ink reservoir to connect with an ink inlet of the inkjet printhead, the ink reservoir extending along a length of the ink supply bezel in parallel with the opening; an ink supply port disposed at one end of the ink reservoir to supply ink thereto; and an air discharge port disposed at another end of the ink reservoir opposite to the one end and to remove bubbles from the ink stored in the ink reservoir, wherein the ink supply port extends from a first end thereof at a bottom surface of the ink reservoir upward to a second end thereof through a top surface of the ink reservoir, and the air discharge port extends from a first end thereof at the top surface and therethrough.

The top surface of the ink reservoir may incline from the first end of the ink supply port to the first end of the air discharge port.

The foregoing and/or other aspects and utilities of the present general inventive concept are achieved by providing an ink supply bezel usable with an inkjet printhead, the ink supply bezel including an opening extending lengthwise to receive piezo-electric actuators; an ink reservoir to supply ink to an ink inlet of the inkjet printhead, the ink reservoir extending in parallel with the opening and having a tapered interior portion; an ink supply port extending upward from one end of the ink reservoir to supply ink thereto; and an air discharge port extending from another end of the ink reservoir opposite to the one end and to remove bubbles from the ink stored in the ink reservoir.

The tapered interior portion may include a horizontal bottom surface and a top surface that inclines at an angle away from the bottom surface.

The ink supply port extends from an end of the top surface which is closest to the bottom surface and the air discharge port extends from an end of the top surface which is farthest away from the bottom surface.

The foregoing and/or other aspects and utilities of the present general inventive concept are achieved by providing an inkjet printhead including a channel plate including an ink channel having an ink inlet to receive ink, a plurality of chambers to be filled with the ink received through the ink inlet, and a plurality of nozzles through which the ink is ejected from the chambers; actuators formed on the channel plate to apply driving forces to eject ink from the chambers; and an ink-supply bezel coupled to a top surface of the channel plate and including an ink reservoir connected to the ink inlet to store ink to be supplied to the ink channel of the channel plate, an ink supply port extending from a bottom portion of the ink reservoir and an air discharge port extending from a top portion of the ink reservoir to discharge bubbles from a top surface of the ink stored in the ink reservoir.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a cross-sectional view schematically illustrating a general structure of a conventional piezoelectric inkjet printhead;

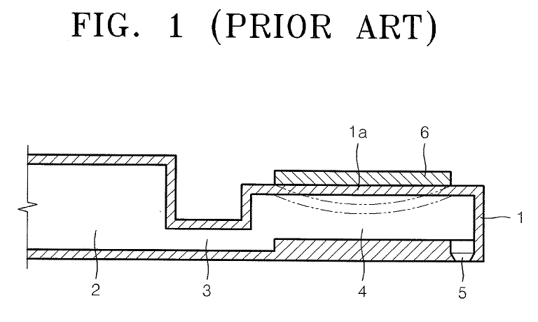

FIG. 2 is a perspective view illustrating an example of a conventional piezoelectric inkjet printhead;

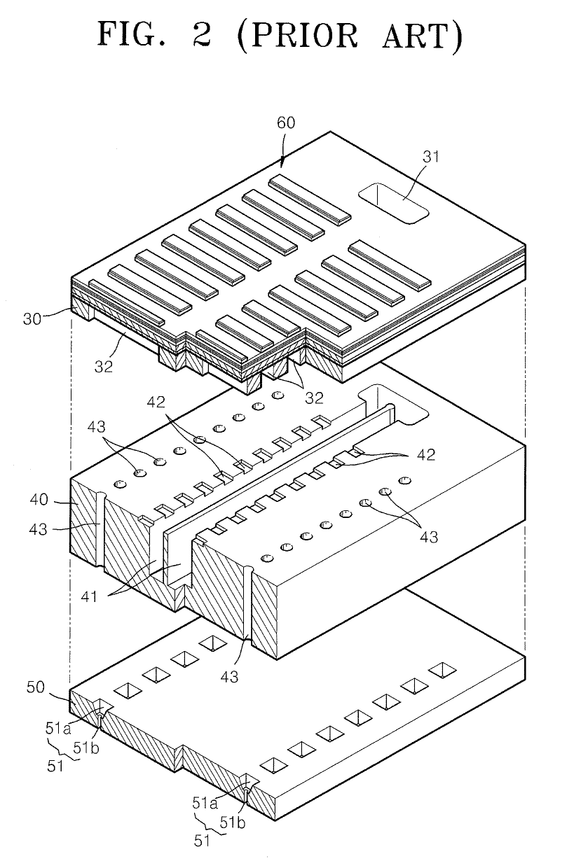

FIG. 3 is an exploded perspective view illustrating an inkjet printhead having a bezel structure according to an embodiment of the present general inventive concept;

FIG. 4A is a vertical cross-sectional view of the inkjet printhead of FIG. 3, taken in a length direction of a pressure chamber of the inkjet printhead explaining an assembled state of the inkjet printhead, according to an embodiment of the present general inventive concept;

FIG. 4B is a vertical cross-sectional view taken along line A-A′ of FIG. 4A, according to an embodiment of the present general inventive concept; and

FIG. 5 is a vertical cross-sectional view illustrating an inkjet printhead having a bezel structure according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

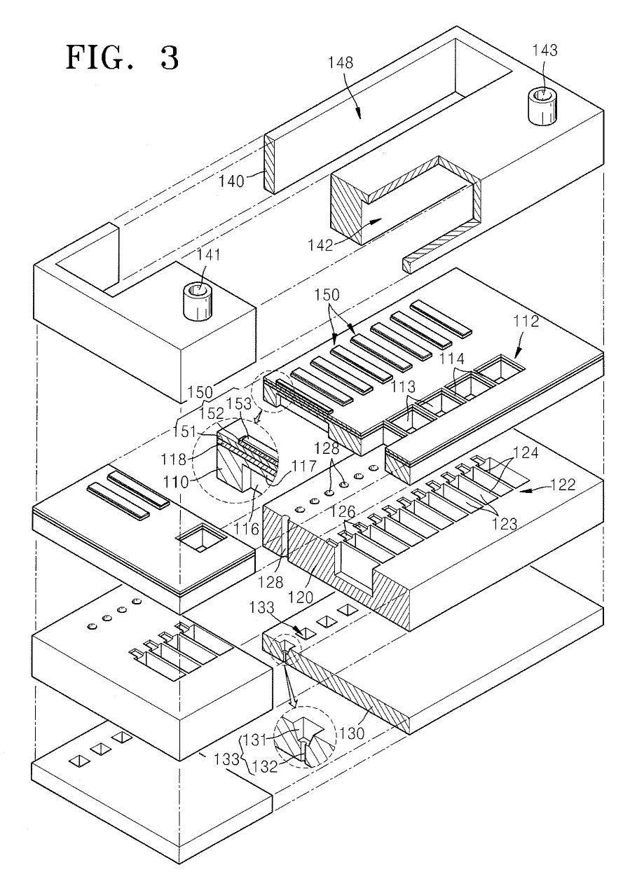

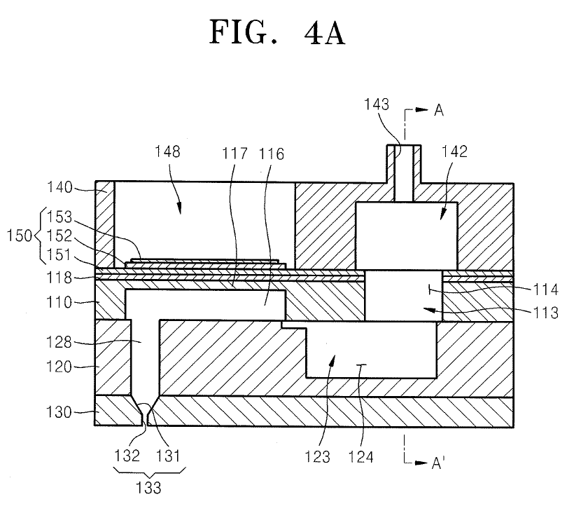

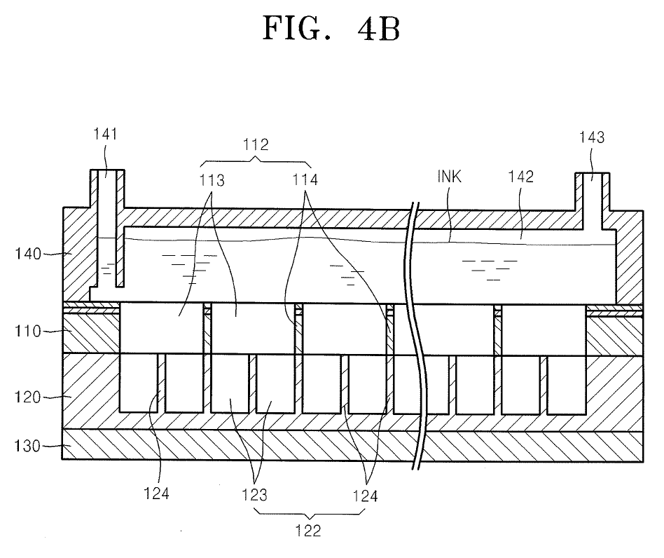

FIG. 3 is an exploded perspective view illustrating an inkjet printhead having a bezel structure according to an embodiment of the present general inventive concept, FIG. 4A is a vertical cross-sectional view of the inkjet printhead of FIG. 3, taken in a length direction of a pressure chamber of the inkjet printhead explaining an assembled state of the inkjet printhead according to an embodiment of the present general inventive concept, and FIG. 4B is a vertical cross-sectional view taken along line A-A′ of FIG. 4A, according to an embodiment of the present general inventive concept.

Referring to FIGS. 3, 4A, and 4B, the inkjet printhead of the current embodiment includes channel plates 110, 120, and 130 in which an ink channel is formed, actuators 150 formed on the channel plate 110 to apply driving forces to eject ink, and an ink-supply bezel 140 coupled to the channel plate 110.

The ink channel formed in the channel plates 110, 120, and 130 includes an ink inlet 112 allowing an inflow of ink from an ink tank (not illustrated), a plurality of chambers 116 in which ink received through the ink inlet 112 is filled, and a plurality of nozzles 133 through which ink is ejected from the chambers 116. The ink channel may further include a manifold 122 to distribute ink received through the ink inlet 112 to the chambers 116, and a plurality of restrictors 126 respectively connecting the manifold 122 to the chambers 116. The ink channel may further include a plurality of dampers 128 to respectively connect the chambers 116 to the nozzles 133. The ink channel will be described later in more detail.

The inkjet printhead includes three channel plates 110, 120, and 130 in the current embodiment, however, the present general inventive concept is not limited thereto, and the inkjet printhead can include two or more channel plates. The channel plates 110, 120, and 130 are exemplarily illustrated in FIGS. 3, 4A, and 4B. Hence, the inkjet printhead of the present general inventive concept is characterized by the ink-supply bezel 140 formed on the channel plates 110, 120, and 130 as described below.

The channel plates 110, 120, and 130 may be formed of and hereinafter referred to respectively as an upper substrate 110, a middle substrate 120, and a lower substrate 130. In this case, the actuators 150 can be formed on a top surface of the upper substrate 110. The upper, middle, and lower substrates 110, 120, and 130 may be silicon substrates that are widely used for semiconductor integrated circuits.

The ink-supply bezel 140 includes an ink reservoir 142, an ink supply port 141, and an air discharge port 143. The ink reservoir 142 is connected to the ink inlet 112 and stores ink that is to be supplied to the ink channel. The ink is supplied to the ink reservoir 142 through the ink supply port 141. The air discharge port 143 is formed to remove bubbles from the ink stored in the ink reservoir 142.

The ink reservoir 142 may have a shape corresponding to that of the ink inlet 112. Hence, the ink reservoir 142 may have a rectangular shape. The ink supply port 141 may be formed at one end of the top surface of the ink reservoir 142, and the air discharge port 143 may be formed at the other end of the top surface of the ink reservoir 142. Hence, the ink supply port 141 and the air discharge port 143 may be spaced apart from each other.

A bottom end of the ink supply port 141 formed in the ink reservoir 142 may be lower than that of the air discharge port 143. In detail, the ink supply port 141 can be formed in such a manner that the bottom end of the ink supply port 141 is immersed in the ink stored in the ink reservoir 142. In this case, a capillary phenomenon can easily occur at the ink supply port 141, and bubbles contained in the ink of the reservoir 142 can easily move upward to the surface of the ink stored in the ink reservoir 142 by supplying ink to the bottom of the ink stored in the ink reservoir 142 through the ink supply port 141. The bottom end of the air discharge port 143 can be flush with the ceiling of the ink reservoir 142. Thus, bubbles that rise and burst on the surface of the ink stored in the ink reservoir 142 can be easily discharged through the air discharge port 143.

As described above, the ink that is to be supplied to the ink channel of the inkjet printhead is first stored in the ink reservoir 142, and bubbles contained in the ink smoothly move upward to the surface of the ink, and are discharged through the air discharge port 143. In this way, bubbles are removed from the ink before the ink is supplied to the ink channel of the inkjet printhead, and thereby, preventing the bubbles from affecting the ink ejection performance of the inkjet printhead is achieved.

An opening 148 is formed in the ink-supply bezel 140 to expose the actuators 150 formed on the top surface of the upper substrate 110 to the outside. A flexible printed circuit (FPC) (not illustrated) can be connected to the actuators 150 through the opening 148 to apply voltages to the actuators 150.

The ink channel of the inkjet printhead will now be described in more detail. The chambers 116 can be formed in the bottom surface of the upper plate 110 to a predetermined depth. Portions of the upper substrate 110 forming top walls of the chambers 116 are referred to as vibration plates 117. The vibration plates 117 are vibrated by the actuators 150. The chambers 116 can be arranged along the manifold 122 in a row, and each of the chambers 116 can have a rectangular shape with its length in a direction of ink flow.

The manifold 122 can be formed in a top surface of the middle substrate 120 to a predetermined depth. Alternatively, the manifold 122 can be formed vertically through the middle substrate 120. The manifold 122 can be divided by first barrier walls 124 into a plurality of sub manifolds 123 respectively corresponding to the chambers 116. The sub manifolds 123 are respectively connected to the chambers 116 through the restrictors 126. The sub manifolds 123 can be arranged in parallel with the chambers 116. Hence, in the inkjet printhead of the current embodiment, the chambers 116 can respectively correspond to the sub manifolds 123 instead of the chambers 116 corresponding to a common manifold.

As explained above, the sub manifolds 123, which are apart from each other by the first barrier walls 124, are connected to the chambers 116 through the restrictors 126, respectively. Therefore, even when ink reversely flows from one of the chambers 116 to its corresponding sub manifold 123 through the restrictor 126 during an ink ejection process, neighboring chambers 116 and sub manifolds 123 are not affected by an abnormal pressure caused by the reverse flow of ink due to the first barrier walls 124. Therefore, cross talk between neighboring chambers 116 can be effectively prevented during an ink ejection process due to the first barrier walls 124.

The restrictors 126 can be formed in the top surface of the middle substrate 120 to a predetermined depth as paths connecting the chambers 116 to the sub manifolds 123. The restrictors 126 can be formed in a structure different from that illustrated in FIG. 3.

The ink inlet 112 can be formed vertically through the upper substrate 110 to allow inflow of ink from the ink reservoir 142 to the sub manifolds 123. The ink inlet 112 can be a common inlet for the sub manifolds 123. However, like the manifold 122, the ink inlet 112 can be divided into a plurality of sub ink inlets 113 by second barrier walls 114. However, each of the sub ink inlets 113 can correspond to two, three, or four sub manifolds 123. For example, as illustrated in FIG. 4B, each of the sub ink inlets 113, which are separate from each other by the second barrier walls 114, corresponds to two sub manifolds 123.

Since the ink inlet 112 is divided into the sub ink inlets 113 by the second barrier walls 114, crosstalk between neighboring sub ink inlets 113 can be prevented more effectively, and the amount of ink supplied to each of the sub manifolds 123 can be uniformly controlled.

The dampers 128 can be formed vertically through the middle substrate 120 to be connected with the chambers 116, respectively.

The nozzles 133 can be formed vertically through the lower substrate 130 in connection with the dampers 128, respectively. Each of the nozzles 133 can include an ink ejection port 132 and an ink introduction portion 131. The ink ejection port 132 is formed in a lower portion of the lower substrate 130 to eject ink, and the ink introduction portion 131 is formed in an upper portion of the lower substrate 130 to guide ink from the damper 128 to the ink ejection port 132. The ink ejection port 132 can be a vertical cylindrical port having a constant diameter. The ink introduction portion 131 can have a reversed quadrangular pyramid shape with a cross section decreasing from the damper 128 to the ink ejection port 132.

The actuators 150 can be formed on the top surface of the upper substrate 110. An insulation layer 118 can be formed between the upper substrate 110 and the actuators 150. If the upper substrate 110 is a silicon substrate, the insulation layer 118 can be formed of a silicon oxide. Each of the actuators 150 can include a lower electrode 151, a piezoelectric layer 152 that deforms due to an applied voltage, and an upper electrode 153 used as a driving electrode. The lower electrode 151 can be used as a common electrode for all the actuators 150. In this case, the lower electrode 151 can be formed on the entire surface of the insulation layer 118 using a conductive metal. The piezoelectric layer 152 is formed on the lower electrode 151 above a corresponding chamber 116. The piezoelectric layer 152 may be formed of a piezoelectric material such as a lead zirconate titanate (PZT) ceramic material. If a voltage is applied to the piezoelectric layer 152, the piezoelectric layer 152 deforms, and thus, the vibration plate 117 forming a top wall of the chamber 116 can vibrate. The upper electrode 153 is formed on the piezoelectric layer 152 as a driving electrode that applies a voltage to the piezoelectric layer 152.

The inkjet printhead of the current embodiment can be formed by coupling the ink-supply bezel 140 to the upper substrate 110 after bonding the upper substrate 110, the middle substrate 120, and the lower substrate 130 to one another. In the upper, middle, and lower substrates 110, 120, and 130, the sub ink inlets 113, the sub manifolds 123, the restrictors 126, the chambers 116, the dampers 128, and the nozzles 133 are sequentially connected to form the ink channel in the inkjet printhead.

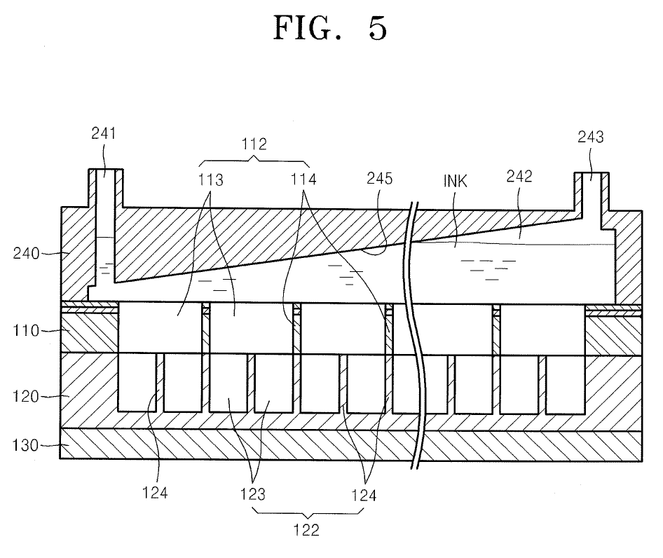

FIG. 5 is a vertical cross-sectional view illustrating an inkjet printhead having a bezel structure according to another embodiment of the present general inventive concept.

Referring to FIG. 5, the inkjet printhead of the current embodiment includes channel plates 110, 120, and 130 in which an ink channel is formed, actuators (not illustrated), and an ink-supply bezel 240. The ink channel, the channel plates 110, 120, and 130, and the actuators have the same structures as those of the inkjet printhead of FIG. 3, and thus, descriptions thereof will be omitted.

The ink-supply bezel 240 is coupled to a top portion of the channel plate 110. The ink-supply bezel 240 includes an ink supply port 241, an ink reservoir 242, and an air discharge port 243. The ink supply port 241, the ink reservoir 242, and the air discharge port 243 are similar to those of the inkjet printhead of FIG. 3, and thus, descriptions thereof will be omitted.

In the current embodiment, the ink reservoir 242 has a sloped ceiling surface 245. In detail, the sloped ceiling surface 245 of the ink reservoir 242 is sloped upward from a bottom end of the ink supply port 241 to a bottom end of the air discharge port 243.

Since the ceiling surface 245 of the ink reservoir 242 is sloped in this manner, bubbles rising from the ink filled in the ink reservoir 242 can be easily discharged to the outside through the air discharge port 243.

Hereinafter, an operation of the inkjet printhead will now be described with reference to FIGS. 3, 4A, and 4B, according to an embodiment of the present general inventive concept.

Ink is supplied from an ink tank (not illustrated) to the ink reservoir 142 through the ink supply port 141. As described above, bubbles contained in the ink of the ink reservoir 142 move upward to the surface of the ink, and are discharged to the outside through the air discharge port 143. Then, the ink flows into the sub manifolds 123 that are separate from each other by the first barrier walls 124 through the sub ink inlets 113, which are separate from each other, by the second barrier walls 114. Thereafter, the ink is supplied to the chambers 116 from the sub manifolds 123 through the restrictors 126. After the chambers 116 are filled with the ink, a voltage is applied to the piezoelectric layer 152 of the actuators 150 through the upper electrode 153. Then, the piezoelectric layer 152 deforms to bend the vibration plate 117 downward. As a result, one of the chambers 116 corresponding to the bent vibration plate 117 increases in pressure, and thus, ink is discharged from the chamber 116 to the outside through the corresponding damper 128 and nozzle 133. At this point, some of the ink can flow in reverse from the chamber 116 to the corresponding sub manifold 123 through the corresponding restrictor 126. However, neighboring sub manifolds 123 and chambers 116 are not affected by the reverse flow of ink since the first barrier walls 124 separate the sub manifolds 123.

If the voltage applied to the piezoelectric layer 152 of the actuators 150 is interrupted, the piezoelectric layer 152 returns to its original shape, and the vibration plate 117 returns to its original shape. Therefore, the volume of the chamber 116 increases to its original level. As a result, the pressure of the chamber 116 decreases, and a meniscus is formed on ink in the nozzle 133 due to a surface tension. Thus, ink can be refilled into the chamber 116 from the sub manifold 123 through the restrictor 126.

As described above, according to various embodiments of the present general inventive concept, an inkjet printhead includes an ink-supply bezel having an ink reservoir and an air discharge port so that bubbles can be effectively removed from the ink in the ink reservoir before the ink is supplied to an ink channel of the inkjet printhead. Therefore, the ink ejection efficiency and print quality of the inkjet printhead are not decreased by bubbles.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printhead comprising:
a channel plate including an ink channel, the ink channel including an ink inlet to receive ink, a plurality of chambers to be filled with the ink received through the ink inlet, and a plurality of nozzles through which the ink is ejected from the chambers;
actuators formed on the channel plate to apply driving forces to eject ink from the chambers; and
an ink-supply bezel coupled to a top surface of the channel plate, the ink-supply bezel including:
an ink reservoir that is connected to the ink inlet and stores ink to be supplied to the ink channel of the channel plate;
an ink supply port through which ink is supplied to the ink reservoir; and
an air discharge port through which bubbles removed from the ink stored in the ink reservoir are discharged.

2. The inkjet printhead of claim 1, wherein the ink supply port and the air discharge port are formed close to respective opposite ends of the top surface of the ink reservoir.

3. The inkjet printhead of claim 1, wherein the ink supply port has a bottom end lower than a bottom end of the air discharge port.

4. The inkjet printhead of claim 3, wherein the bottom end of the ink supply port is immersed in the ink stored in the ink reservoir.

5. The inkjet printhead of claim 3, wherein the bottom end of the air discharge port is flush with a ceiling surface of the ink reservoir.

6. The inkjet printhead of claim 3, wherein the ink reservoir comprises a sloped ceiling surface.

7. The inkjet printhead of claim 6, wherein the ceiling surface of the ink reservoir is sloped upward from the bottom end of the ink supply port to the bottom end of the air discharge port.

8. The inkjet printhead of claim 1, wherein the ink-supply bezel comprises an opening through which the actuators are exposed.

9. The inkjet printhead of claim 1, wherein the ink channel further includes:
a manifold to supply the ink received through the ink inlet to the chambers; and
a plurality of restrictors to respectively connect the manifold to the chambers.

10. The inkjet printhead of claim 9, wherein the manifold comprises a plurality of sub manifolds that are separate from each other by a plurality of first barrier walls respectively corresponding to the chambers.

11. The inkjet printhead of claim 10, wherein the ink inlet comprises a plurality of sub ink inlets that are separate from each other by a plurality of second barrier walls.

12. The inkjet printhead of claim 11, wherein each of the sub ink inlets corresponds to two to four of the sub manifolds.

13. The inkjet printhead of claim 1, wherein the channel plate comprises an upper substrate, a middle substrate, and a lower substrate.

14. The inkjet printhead of claim 13, wherein the ink channel further includes:
a manifold to supply the ink received through the ink inlet to the chambers; and
a plurality of restrictors to respectively connect the manifold to the chambers,
wherein the chambers are formed in a bottom surface of the upper substrate to a predetermined depth, the ink inlet is formed vertically through the upper substrate, the manifold and the restrictors are formed in the middle substrate, and the nozzles are formed vertically through the lower substrate.

15. The inkjet printhead of claim 14, wherein the ink channel further includes a plurality of dampers formed vertically through the middle substrate to respectively connect the chambers to the nozzles.

16. The inkjet printhead of claim 13, wherein each of the actuators comprises:
a lower electrode formed on the upper substrate;
a piezoelectric layer formed on the lower electrode above the chamber; and
an upper electrode formed on the piezoelectric layer to apply a voltage to the piezoelectric layer.

17. An ink supply bezel usable with an inkjet printhead, the ink supply bezel comprising:
an opening extending along a length thereof to receive piezo-electric actuators;
an ink reservoir to connect with an ink inlet of the inkjet printhead, the ink reservoir extending along a length of the ink supply bezel in parallel with the opening;
an ink supply port disposed at one end of the ink reservoir to supply ink thereto; and
an air discharge port disposed at another end of the ink reservoir opposite to the one end and to remove bubbles from the ink stored in the ink reservoir,
wherein the ink supply port extends from a first end thereof at a bottom surface of the ink reservoir upward to a second end thereof through a top surface of the ink reservoir, and the air discharge port extends from a first end thereof at the top surface and therethrough.

18. The ink supply bezel of claim 17, wherein the top surface of the ink reservoir inclines from the first end of the ink supply port to the first end of the air discharge port.

19. An ink supply bezel usable with an inkjet printhead, the ink supply bezel comprising:
an opening extending lengthwise to receive piezo-electric actuators;
an ink reservoir to supply ink to an ink inlet of the inkjet printhead, the ink reservoir extending in parallel with the opening and having a tapered interior portion;
an ink supply port extending upward from one end of the ink reservoir to supply ink thereto; and
an air discharge port extending from another end of the ink reservoir opposite to the one end and to remove bubbles from the ink stored in the ink reservoir.

20. The ink supply bezel of claim 19, wherein the tapered interior portion includes a horizontal bottom surface and a top surface that inclines at an angle away from the bottom surface.

21. The ink supply bezel of claim 20, wherein the ink supply port extends from an end of the top surface which is closest to the bottom surface and the air discharge port extends from an end of the top surface which is farthest away from the bottom surface.

22. An inkjet printhead comprising:
a channel plate including an ink channel having an ink inlet to receive ink, a plurality of chambers to be filled with the ink received through the ink inlet, and a plurality of nozzles through which the ink is ejected from the chambers;
actuators formed on the channel plate to apply driving forces to eject ink from the chambers; and
an ink-supply bezel coupled to a top surface of the channel plate and including:
an ink reservoir connected to the ink inlet to store ink to be supplied to the ink channel of the channel plate;
an ink supply port extending from a bottom portion of the ink reservoir; and
an air discharge port extending from a top portion of the ink reservoir to discharge bubbles from a top surface of the ink stored in the ink reservoir.
